(19) United States
(12) Patent Application Publication
(10) Pub. No.: US 2015/0172865 A1
(43) Pub. Date: Jun. 18, 2015

(54) METHOD AND APPARATUS FOR IMPROVED POSITION DETERMINATION ON A MOBILE DEVICE

(71) Applicant: QUALCOMM Incorporated, San Diego, CA (US)

(72) Inventors: Amir Abbas EMADZADEH, Campbell, CA (US); Sai Pradeep Venkatraman, Santa Clara, CA (US); Sundar Raman, San Diego, CA (US)

(73) Assignee: QUALCOMM Incorporated, San Diego, CA (US)

(21) Appl. No.: 14/132,513

(22) Filed: Dec. 18, 2013

(51) Int. Cl. H04W 4/02

(52) U.S. Cl. CPC H04W 4/023

(57) ABSTRACT

Methods, systems, computer-readable media, and apparatuses for obtaining a location fix for a mobile device are presented. In some embodiments, a method includes identifying a region in which the mobile device is located. The method further includes receiving assistance data pertaining to one or more access points within the region, wherein the assistance data is indicative of signal information pertaining to the one or more access points at multiple locations within the region. The method also includes generating, at the mobile device, a heatmap representative of multiple locations within the region as compared against the signal information pertaining to the one or more access points that are in communication range. The method additionally includes determining the location fix based at least in part on the generated heatmap.

### BACKGROUND

Aspects of the disclosure relate to navigation. More specifically, aspects of the disclosure relate to indoor position determination of a wireless communication device.

Advancements in wireless communication technology have greatly increased the versatility of today's wireless communication devices. These advancements have enabled wireless communication devices to evolve from simple mobile telephones and pagers into sophisticated computing devices capable of a wide variety of functionality such as multimedia recording and playback, event scheduling, word processing, e-commerce, etc. As a result, users of today's wireless communication devices are able to perform a wide range of tasks from a single, portable device that conventionally required either multiple devices or larger, non-portable equipment.

Various applications are obtained and utilized to locate the position of a wireless communication device. For instance, location based services (LBSs) leverage the location of an associated device to provide controls for one or more applications running on the device. Applications of LBS functionality implemented with respect to wireless communication devices include personal navigation, social networking, targeting of content (e.g., advertisements, search results, etc.), among others. For some positioning systems, such as indoor positioning systems, areas are defined in terms of regions or other units.

### BRIEF SUMMARY

Certain embodiments describe a method and apparatus for improved position determination on a mobile device.

Systems and methods disclosed herein allow for generation of a localized heatmap, for obtaining a position fix, on the fly at a mobile device. By generating the heatmap at the mobile device, the heatmap may not need to be generated at the server and the need for sending a large file to the mobile device may not be necessary. Further, by only generating a heatmap for access points (APs) within communication range of the mobile device, the size of the heatmap and processing power required to generate it drops dramatically.

In some embodiments, a method for generating a heatmap on a mobile device includes identifying a region in which the mobile device is located. The method further includes receiving assistance data pertaining to one or more access points within the region, wherein the assistance data is indicative of signal information pertaining to the one or more access points at multiple locations within the region. The method also includes generating, at the mobile device, a heatmap representative of multiple locations within the region as compared against the signal information pertaining to the one or more access points that are in communication range of the mobile device. The method additionally includes determining a location fix of the mobile device based at least in part on the generated heatmap.

In some embodiments, the receiving step further comprises determining one or more access points within the region that are in communication range of the mobile device.

In some embodiments, the determining step further comprises refining an estimated position of the mobile device based at least in part on the generated heatmap.

In some embodiments, the method further includes repeating the identifying step, receiving step, and the determining step in response to determining a change in which access points are within communication range of the mobile device, wherein the determining is based on a change in the signal information.

In some embodiments, the signal information received at the multiple locations comprises at least one of a received signal strength indication (RSSI) and round-trip time (RTT).

In some embodiments, the assistance data is further indicative of distances between the multiple locations and the access point.

In some embodiments, the identifying step further includes determining an access point that is in communication range of the mobile device having a highest received signal strength and identifying the region as a region in which the access point is located.

In some embodiments, the assistance data is received from a server computer.

In some embodiments, an apparatus for obtaining a location fix includes a processor, a region identifying module, and a wireless transceiver. The processor is configured to generate at the mobile device, a heatmap representative of multiple locations within a region in which the mobile device is located as compared against signal information pertaining to one or more access points that are in communication range of the mobile device. The processor is further configured to determine a location fix of the mobile device based at least in part on the generated heatmap. The region identifying module is communicatively coupled to the processor and configured to identify the region in which the mobile device is located. The wireless transceiver is coupled to the processor and configured to receive assistance data pertaining to one or more access points within the region, wherein the assistance data is indicative of the signal information pertaining to the one or more access points at multiple locations within the region.

In some embodiments, an apparatus includes means for generating a heatmap on a mobile device. The apparatus further includes means for receiving assistance data pertaining to one or more access points within the region, wherein the assistance data is indicative of signal information pertaining to the one or more access points at multiple locations within the region. The apparatus additionally includes means for generating, at the mobile device, a heatmap representative of multiple locations within the region as compared against the signal information pertaining to the one or more access points that are in communication range of the mobile device. The apparatus also includes means for determining a location fix of the mobile device based at least in part on the generated heatmap.

In some embodiments, a processor-readable, non-transitory, computer readable medium includes processor readable instructions configured to cause a processor, on a mobile device, to identify a region within the indoor venue in which the mobile device is located. The processor readable instructions are further configured to cause the processor to receive assistance data pertaining to one or more access points within the region, wherein the assistance data is indicative of signal information pertaining to the one or more access points at multiple locations within the region. The processor readable instructions are further configured to cause the processor to generate, at the mobile device, a heatmap representative of multiple locations within the region as compared against the signal information pertaining to the one or more access points that are in the communication range of the mobile device. The processor readable instructions are further configured to cause the processor to determine the location fix of the mobile device based at least in part on the generated heatmap.

### BRIEF DESCRIPTION OF THE DRAWINGS

Aspects of the disclosure are illustrated by way of example. In the accompanying figures, like reference numbers indicate similar elements, and:

FIG. 1 is a schematic diagram of a wireless telecommunication system;

FIG. 2 is a block diagram of components of a mobile device shown in FIG. 1, according to an embodiment of the present invention;

FIG. 3 is a block diagram of a server computer, according to an embodiment of the present invention;

FIG. 4 is a generalized block diagram of a wireless communication network supporting position location;

FIG. 5A is an exemplary assistance data entry within an indoor AP database, according to an embodiment of the present invention;

FIG. 5B is another exemplary assistance data entry within an indoor AP database, according to an embodiment of the present invention;

FIG. 5C is an exemplary top-down view of an indoor venue, according to an embodiment of the present invention;

FIG. 6 is an illustrative flow chart depicting an exemplary operation for generating a heatmap on a mobile device within an indoor venue; and

FIG. 7 illustrates an example of a computing system in which one or more embodiments may be implemented.

### DETAILED DESCRIPTION

Several illustrative embodiments will now be described with respect to the accompanying drawings, which form a part hereof While particular embodiments, in which one or more aspects of the disclosure may be implemented, are described below, other embodiments may be used and various modifications may be made without departing from the scope of the disclosure or the spirit of the appended claims.

Obtaining a location fix for a mobile device has become a critically important function in recent years. For mobile devices, there are countless applications that take advantage of mobile device location fixing. For example, a map application can select appropriate maps, direction, driving routes, etc., based on the current location of a mobile device in which it resides. A social networking application can identify other users within the vicinity of a mobile device based on the location of the device. Many other examples exist.

Different techniques for obtaining a position fix for a mobile device may be appropriate under different conditions. In an outdoor environment, satellite-based approaches, e.g., GNSS (Global Navigation Satellite System) techniques, may be suitable if the mobile device is able to receive satellite-based positioning signals such that specific timing requirements are satisfied. Based on the received satellite signals a position fix for the mobile device may be calculated. However, satellite-based approaches may not be used in indoor environments, because the necessary satellite signals typically may not be sufficiently strong to be received indoors.

In indoor environments such as those that exist with shopping malls, airports, sports arenas, etc., access point-based methods are generally more useful for obtaining a location fix for a mobile device. Commonly, the location fix can be obtained using data uniquely associated with individual access points, such as RSSI (Received Signal Strength Indication) and RTT (Round-trip Time). Such data allows the mobile device to estimate the distance between the device and the AP associated with the data.

To estimate the location of detected APs in an area of interest, a server containing assistance data about the indoor venue may generate and send the relevant assistance data to the mobile device. Whether the assistance data is relevant may be determined based on a current region of the indoor venue that the mobile device is currently located in. Rather than the server generating a “heatmap” for all APs within the indoor venue and sending the generated heatmap to the mobile device, or sending all the assistance data to the mobile device, the server may only send assistance data to the mobile device relevant to the region that the mobile device is currently located within. Sending the heatmap from the server to the mobile device requires the transmission of a large amount of data because the heatmap is a large file. Further, the large heatmap needs to be stored on the mobile device, taking up available memory.

The heatmap is a 3-dimensional map generated using proximity data saved in the server's memory. The proximity data includes information pertaining to APs within a geospace and expected RSSI and/or RTT data for each AP. Each heatmap is used to describe the proximity data detected for the AP corresponding to the heatmap. In some embodiments, there may be a separate heatmap generated for each AP within the indoor venue.

Systems and methods disclosed herein allow for generation of a localized heatmap on the fly at the mobile device. The assistance data associated with an indoor venue may be measured ahead of time and stored within the server. The assistance data may include multiple (x, y) coordinates defining locations within the indoor venue and measured data at those coordinates. The measured data may include RSSI or RTT information for each AP. The assistance data relating only to the access points currently accessible by the mobile device within the indoor venue may be sent from the server to the mobile device. The mobile device may locally generate a heatmap from the received assistance data. However, it can be appreciated that the heatmap could differ from the assistance data in that there may be a value generated for each node in a regular grid, whereas the assistance data could be a collection of vectors for irregularly spaced points. The heatmap may be created from the collection of vectors in the assistance data. By sending only the assistance data for the currently accessible APs, the mobile device may not need to receive a large heatmap file from the server. Further, by generating the heatmap locally on the mobile device, the heatmap only needs to be generated for the local access points and not for the entire indoor venue. This method may reduce bandwidth and memory requirements.

Location areas, such as indoor areas including floors of buildings, are defined within a positioning system as regions. These regions are referred to as indoor or outdoor regions and/or by other naming conventions. These areas may also be defined in one or more ways, such as via a location context identifier (LCI) or other means. Each region is defined by assistance data for the region, which may include, but is not limited to, the following: connectivity, utility and heatmap information corresponding to all nodes in the region; coordinates of one or more points (e.g., vertices, etc.) within the region, e.g., relative to a coordinate system defined with respect to the Earth (e.g., latitude/longitude/altitude, etc.), a coordinate system defined with respect to an area that includes the region; size or dimensions (e.g., length and width) of the region given by number of nodes; the media access control (MAC) addresses of the access points (APs) which have influence on the region (i.e., an AP list); etc. As used herein, a “node” refers to a given location within a region, such as an anchor point or any other defined location of interest within the region. The assistance data may also include expected RSSI and RTT information for each AP.

The amount of assistance data associated with a region grows in proportion to the size of the region. Large regions result in large amounts of assistance data, which may be difficult or impractical to process at devices with limited processing ability, memory and/or storage, such as mobile devices. Accordingly, techniques are described herein whereby assistance data relevant to a region that the mobile device is currently within is sent from a server to the mobile device. The mobile device may locally generate a heatmap using the received assistance data only for the APs which are within communication range of the mobile device. It can be appreciated that the term “within communication range”, as used herein is used very loosely. That is, the mobile device need not be able to be within a range required to reliably send and receive data bits to the AP for the AP to be considered within communication range of the mobile device. An AP may be within communication range of the mobile device if RSSI and RTT measurements may be taken, even if the mobile device and AP may not be able to reliably send and receive data bits.

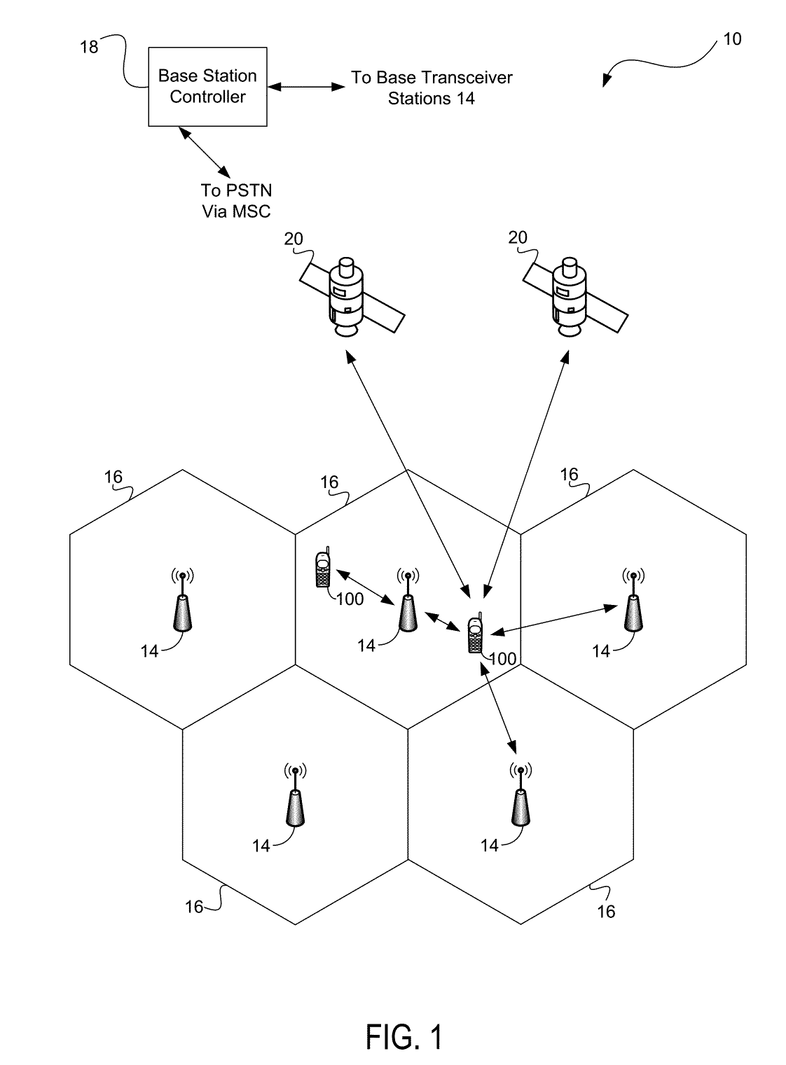

Systems and methods described herein operate via one or more mobile devices operating in a wireless communication system. Referring to FIG. 1, a wireless communication system 10 includes base transceiver stations (BTSs) 14 disposed in cells 16. The BTSs 14 provide communication service for a variety of wireless communication devices, referred to herein as mobile devices 12. Wireless communication devices served by a BTS 14 can include, but are not limited to, personal digital assistants (PDAs), smartphones, computing devices such as laptops, desktops or tablet computers, automobile computing systems, etc., whether presently existing or developed in the future.

The wireless communication system 10 may support operation on multiple carriers (waveform signals of different frequencies). Multi-carrier transmitters can transmit modulated signals simultaneously on the multiple carriers. Each modulated signal may be a Code Division Multiple Access (CDMA) signal, a Time Division Multiple Access (TDMA) signal, an Orthogonal Frequency Division Multiple Access (OFDMA) signal, a Single-Carrier Frequency Division Multiple Access (SC-FDMA) signal, etc. Each modulated signal may be sent on a different carrier and may carry pilot, overhead information, data, etc.

The BTS 14 can wirelessly communicate with the mobile devices 12 in the wireless communication system 10 via antennas. A BTS 14 may also be referred to as a base station, an access point, an access node (AN), a Node B, an evolved Node B (eNB), etc. The BTS 14 is configured to communicate with mobile devices 12 via multiple carriers. The BTS 14 can provide communication coverage for a respective geographic area, here the cell 16. The cell 16 of the BTS 14 can be partitioned into multiple sectors as a function of the base station antennas.

The wireless communication system 10 may include only macro base stations 14 or it can have base stations 14 of different types, e.g., macro, pico, and/or femto base stations, etc. A macro base station may cover a relatively large geographic area (e.g., several kilometers in radius) and may allow unrestricted access by terminals with service subscription. A pico base station may cover a relatively small geographic area (e.g., a pico cell) and may allow unrestricted access by terminals with service subscription. A femto or home base station may cover a relatively small geographic area (e.g., a femto cell) and may allow restricted access by terminals having association with the femto cell (e.g., terminals for users in a home).

The mobile devices 12 can be dispersed throughout the cell 16. The mobile devices 12 may be referred to as terminals, access terminals (ATs), mobile stations, user equipment (UE), subscriber units, etc. The mobile devices 12 can include various devices as listed above and/or any other devices.

As further shown in FIG. 1, a mobile device 100 receives navigation signals from a satellite positioning system (SPS), e.g., through SPS satellites 20. The SPS satellites 20 can be associated with a single multiple global navigation satellite system (GNSS) or multiple such systems. A GNSS associated with satellites 20 can include, but are not limited to, Global Positioning System (GPS), Galileo, Glonass, Beidou (Compass), etc. SPS satellites 20 are also referred to as satellites, space vehicles (SVs), etc.

A mobile device 100 within the wireless communication system 10 can estimate its current position within the wireless communication system 10 using various techniques, based on other communication entities within view and/or information available to the mobile device 100. For instance, a mobile device 100 can estimate its position using information obtained from BTSs 14 and/or SPS satellites 20, as well as additional information as described in further detail below.

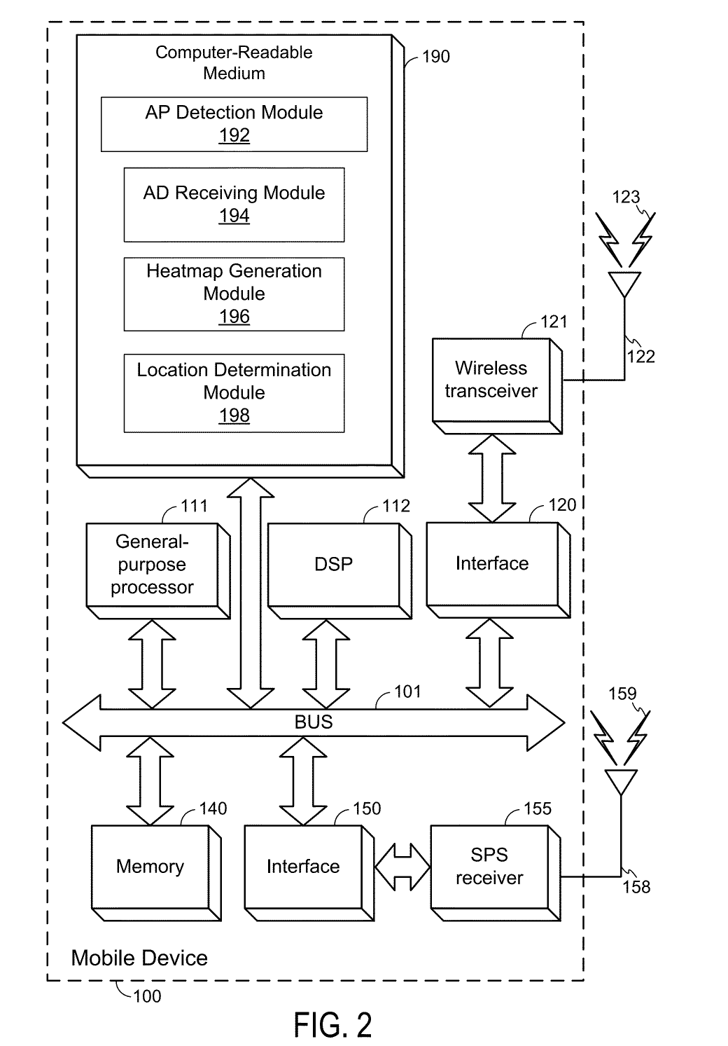

FIG. 2 is a block diagram of components of a mobile device 100 shown in FIG. 1, according to an embodiment of the present invention. Mobile device 100 includes a wireless transceiver 121 that sends and receives wireless signals 123 via a wireless antenna 122 over a wireless network. The transceiver 121 is connected to a bus 101 by a wireless transceiver bus interface 120. While shown as distinct components in FIG. 2, the wireless transceiver bus interface 120 may also be a part of the wireless transceiver 121. Here, the mobile device 100 is illustrated as having a single wireless transceiver 121. However, a mobile device 100 can alternatively have multiple wireless transceivers 121 and wireless antennas 122 to support multiple communication standards such as Wi-Fi, Code Division Multiple Access (CDMA), Wideband CDMA (WCDMA), Long Term Evolution (LTE), Bluetooth, etc.

A general-purpose processor 111, memory 140, digital signal processor (DSP) 112 and/or specialized processor(s) (not shown) may also be utilized to process the wireless signals 123 in whole or in part. Storage of information from the wireless signals 123 is performed using a memory 140 or registers (not shown). While only one general purpose processor 111, DSP 112 and memory 140 are shown in FIG. 2, more than one of any of these components could be used by the mobile device 100. The general purpose processor 111, DSP 112 and memory 140 are connected to the bus 101.

The mobile device 100 also includes an SPS receiver 155 that receives SPS signals 159 (e.g., from SPS satellites 20) via an SPS antenna 158. The SPS receiver 155 processes, in whole or in part, the SPS signals 159 and uses these SPS signals 159 to determine the location of the mobile device 100. The general-purpose processor 111, memory 140, DSP 112 and/or specialized processor(s) (not shown) may also be utilized to process the SPS signals 159, in whole or in part, and/or to calculate the location of the mobile device 100, in conjunction with SPS receiver 155. Storage of information from the SPS signals 159 or other location signals is performed using a memory 140 or registers (not shown).

The mobile device 100 also includes a non-transitory computer-readable storage medium 190 (or media) that stores functions as one or more instructions or code. Media that can make up the computer-readable storage medium 190 include, but are not limited to, RAM, ROM, FLASH, disc drives, etc. Functions stored by the computer-readable storage medium 190 are executed by the general-purpose processor 111, specialized processor(s), or DSP 112. Thus, the computer-readable storage medium 190 is a processor-readable memory and/or a computer-readable memory that stores software (programming code, instructions, etc.) configured to cause the processor 111 and/or DSP 112 to perform the functions described. Alternatively, one or more functions of the mobile device 100 may be performed in whole or in part in hardware.

Computer-readable storage medium 190 includes AP detection module 192, AD receiving module 194, heatmap generation module 196, and location determination module 198.

AP detection module 192 is configured to detect APs currently within communication range of the mobile device 100. AP detection module 192 may interface with wireless transceiver 121 via bus 101 and wireless transceiver bus interface 120 to detect APs currently within communication range of the mobile device 100. Detection of the APs may be accomplished using detection methods supported by multiple communication standards such as Wi-Fi, Code Division Multiple Access (CDMA), Wideband CDMA (WCDMA), Long Term Evolution (LTE), Bluetooth, etc. In some embodiments, the AP detection module 192 may determine which of the detected APs has a highest received signal strength. The AP having the highest detected signal strength may be used to determine a region within an indoor venue that the mobile device 100 is currently located within. AP detection module 192 may also obtain a RSSI and/or RTT value for each AP within the indoor venue.

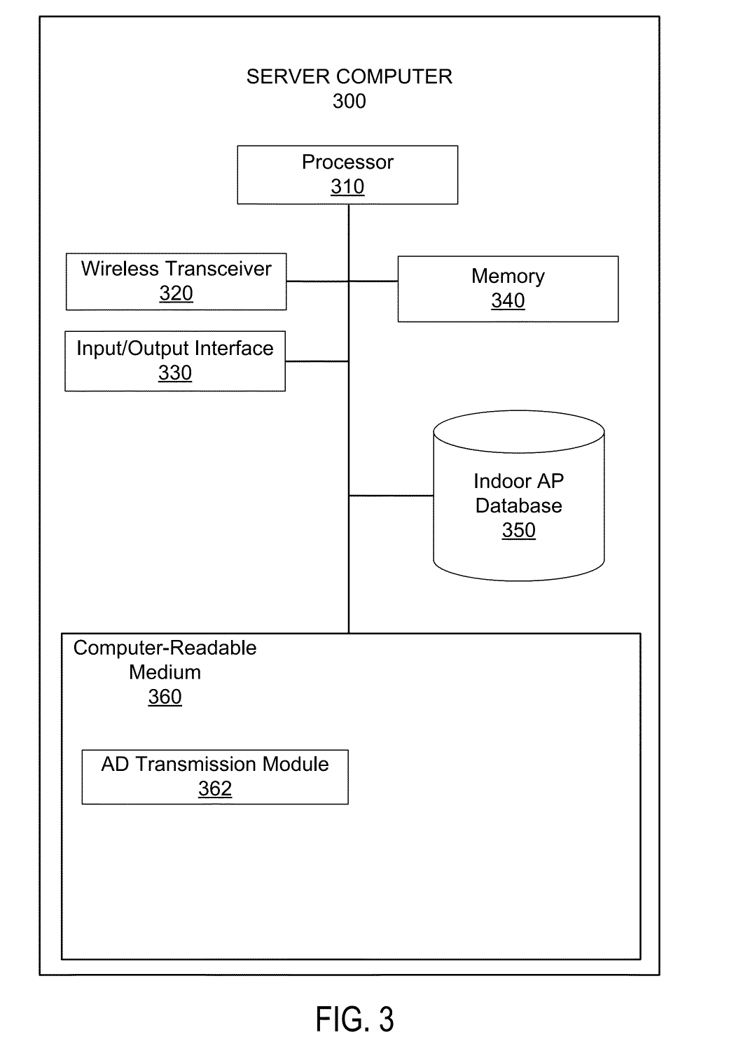

AD receiving module 194 is configured to receive assistance data from a server computer (see FIG. 3). As described above, the assistance data may include RSSI and RTT information about each AP within the indoor venue. The AD receiving module 194 may receive the assistance data from the server computer via wireless transceiver 121. In some embodiments, the server computer may send, to the mobile device 100, assistance data pertaining to the APs detected to be within communication range of the mobile device 100 by AP detection module 192, rather than sending assistance data for every AP within the indoor venue.

The heatmap generation module 196 is configured to generate a heatmap for each AP within communication range of the mobile device 100, as determined by AP detection module 192. The heatmaps may be generated by the assistance data received by AD receiving module 194. The heatmaps may describe the proximity data detected for the AP corresponding to the heatmap. For example, the heatmaps may describe an expected RSSI or RTT value for an AP at a certain (x, y) location coordinate within the indoor venue.

The location determination module 198 is configured to determine a location of the mobile device 100 within the indoor venue. The location may be determined using the heatmap generated by heatmap generation module 196 and obtained RSSI and/or RTT values by AP detection module 192. The obtained RSSI and/or RTT values may be compared against expected RSSI and/or RTT values for an AP at a certain (x, y) location coordinate within the indoor venue. By comparing the obtained values to the expected values, the current (x, y) coordinate of the mobile device 100 may be determined

FIG. 3 is a block diagram of components of a server computer 300, according to an embodiment of the present invention. Server computer 300 includes a wireless transceiver 320, input/output interface 330, a memory 340, a processor 310, an indoor AP database 350, and a computer-readable medium 360.

The input/output (I/O) interface 330 is configured to receive and transmit data. For example, the I/O interface 330 may transmit assistance data to the mobile device 100 (FIG. 1), via the AD transmission module 362. The I/O interface 330 may also be used for direct interaction with the server computer. The I/O interface 330 may accept input from an input device such as, but not limited to, a keyboard, keypad, or mouse. Further, the I/O interface may display output on a display device.

Memory 340 may be any magnetic, electronic, or optical memory. It can be appreciated that memory 340 may include any number of memory modules, that may comprise any suitable volatile or non-volatile memory devices. An example of memory 340 may be dynamic random access memory (DRAM).

Processor 310 may be any general-purpose processor operable to carry out instructions on the server computer 300. The processor 310 is coupled to other units of the server computer 300 including wireless transceiver 320, input/output interface 330, memory 340, indoor AP database 350, and computer-readable medium 360.

Indoor AP database 350 is configured to store information about the APs within the indoor venue and about the indoor venue itself The information may include the positions of each AP within the indoor venue and the assistance data associated with each AP. In some embodiments, the indoor AP database may be populated prior to use of the APs by individual users.

Computer-readable medium 360 may be any magnetic, electronic, optical, or other computer-readable storage medium. Computer-readable medium 360 includes AD transmission module 362. Computer-readable medium 360 may comprise any combination of volatile and/or non-volatile memory such as, for example, buffer memory, RAM, DRAM, ROM, flash, or any other suitable memory device, alone or in combination with other data storage devices.

AD transmission module 362 is configured to send assistance data stored within indoor AP database 350 to the mobile device 100 (FIG. 1). The AD transmission module 362 may interface with wireless transceiver 320 to send the assistance data. The assistance data sent by AD transmission module 362 may be received by AD receiving module 194 (FIG. 2).

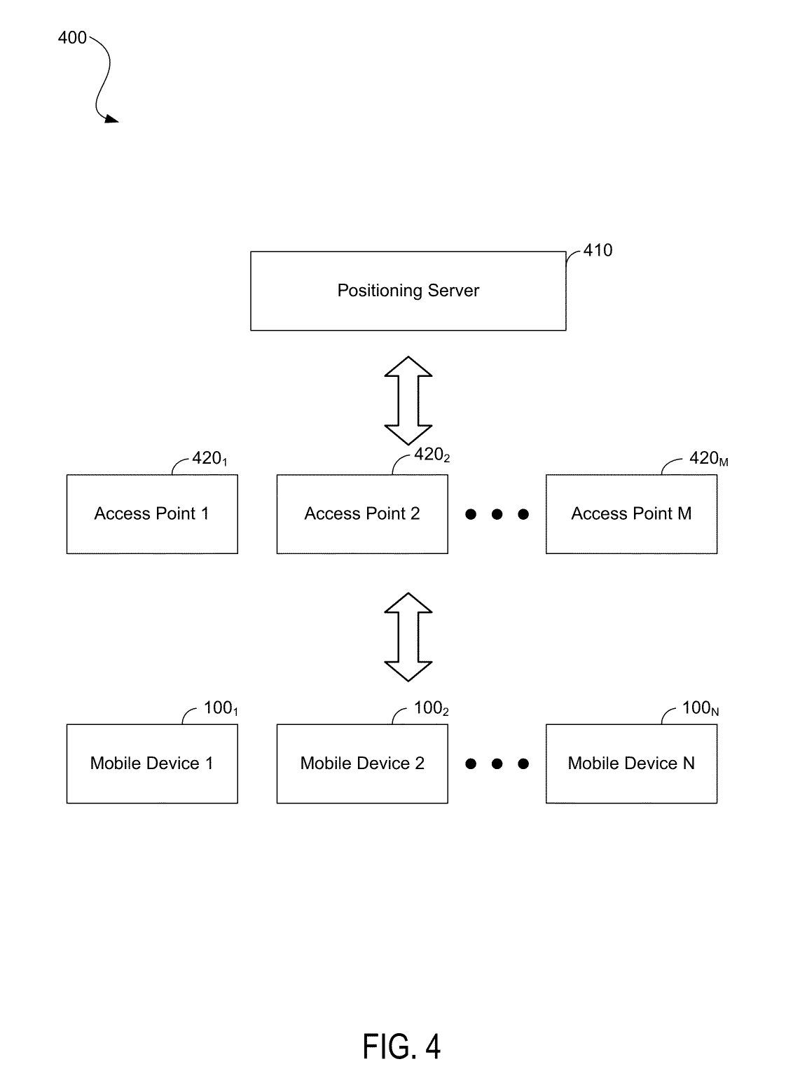

As shown in FIG. 4, one or more mobile devices 100 and access points 420 as described above, together with a positioning server 410, are collectively used to implement a positioning system 400. In some embodiments, positioning server 410 may implement attributes of server computer 300 (FIG. 3). As shown in FIG. 4 and described above, the mobile devices 100 and access points 420 communicate with each other, e.g., over a wireless medium. As further shown in FIG. 4, the access points 420 communicate with the positioning server 410, e.g., over a direct wired or wireless network connection and/or indirectly by way of one or more data networks or the Internet. While not shown in FIG. 4, the mobile devices 100 may also communicate with the positioning server 410, either directly or through the access points 420. Mobile devices 100 and access points 420 may also communicate with each other (e.g., through peer-to-peer and backhaul connections, respectively).

The positioning server 410 maintains positioning assistance data (also referred to as simply “assistance data”) for one or more regions. The assistance data may be stored within indoor AP database 350 (FIG. 3). The positioning server 410 may be a local server that maintains data for only a single region or a small group of regions within an indoor venue. While the positioning server 410 is shown in system 400 as an entity independent of other devices in the system 400, the positioning server 410 may also be implemented at least in part by one or more of the access points 420 and/or mobile devices 100.

The size of the assistance data associated with a region grows in proportion to the size of the region. For instance, the sizes of the connectivity graph, utility map and access map for a given region are a direct function of the size of the region. These components are typically defined for every node of the region and thereby grow as the region grows. Although the heatmap associated with a given region is restricted to an area around respective APs, the size of the heatmap will also increase as region size increases since the number of APs within a region is typically larger for a large region. For very large regions, such as airports or the like, these size increases present challenges to mobile devices in terms of memory usage and computational complexity. In order to avoid these bottlenecks, systems and methods presented herein constrain the size of the assistance data consumed by a mobile device to within the operating capabilities of the mobile device even for very large regions. To these ends, the positioning server 410 is configured to send assistance data pertaining to those APs within a region the mobile device 100 is currently located within, rather than sending assistance data for an entire indoor venue. Further, a mobile device 100 is configured to generate a localized heatmap for each AP that is within communication range of the mobile device 100, rather than generating a heatmap for every AP within the indoor venue.

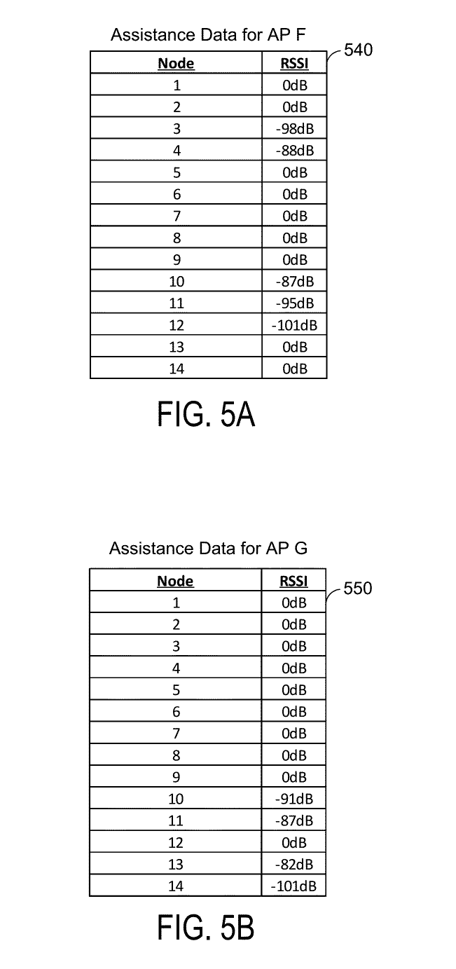

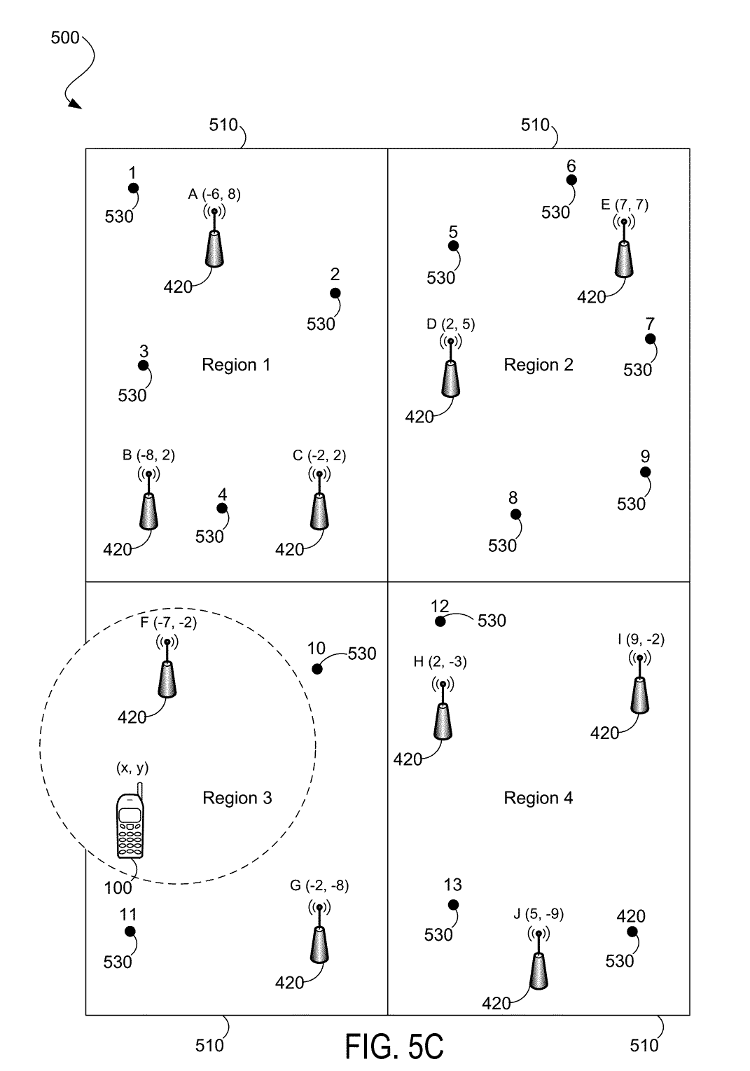

FIG. 5A is an exemplary assistance data entry 540 within an indoor AP database 350 (FIG. 3), according to an embodiment of the present invention. The assistance data entry 540 is for an AP designated as “AP F”. The assistance data entry may include, but is not limited to, nodes within an indoor venue and an expected RSSI value for the AP at each of the nodes. It can be appreciated that while RSSI values are shown in the assistance data entry 540, RTT values may also be shown. In this particular example, expected RSSI values for “AP F” are listed at fourteen nodes within the indoor venue. Some nodes within the indoor venue are at a location not within communication range of “AP F”, and thus have an expected RSSI value of 0. The placement of the nodes and AP can be seen with reference to FIG. 5C.

FIG. 5B is another exemplary assistance data entry 550 within an indoor AP database, according to an embodiment of the present invention. FIG. 5B is similar to FIG. 5A except that the assistance data is for another AP within the indoor venue, designated as “AP G”. As can be seen, AP G has its own characteristics with respect to the expected RSSI values at each node located within the indoor venue. Similarly, the placement of the nodes and AP can be seen with reference to FIG. 5C.

FIG. 5C is an exemplary top-down view of an indoor venue 500, according to an embodiment of the present invention. The indoor venue 500 includes a plurality of regions 510. Specifically, in this example, the indoor venue 500 includes four regions 510. The indoor venue 500 also includes a plurality of nodes 530 at various locations within the indoor venue 500. Specifically, in this example, the indoor venue 500 includes fourteen nodes 530. The indoor venue 500 also includes a plurality of access points 420. Specifically, in this example, the indoor venue includes ten access points 420.

The regions 510 define separate areas within the indoor venue 500. Each region 510 includes a subset of the access points 420 and nodes 530. Assistance data pertaining to each AP 420 within the indoor venue 500 may be stored within an indoor AP database 350 (FIG. 3) as demonstrated in FIGS. 5A-5B. The assistance data may also include each AP's position within the indoor venue 500, expressed as an (x, y) coordinate. For example, AP B in FIG. 5C has an (x, y) coordinate of (−8, 2).

The indoor venue also includes a mobile device 100. The mobile device 100 may be located within any region of the indoor venue 500. The mobile device 100 may be located at an unknown (x, y) position within the indoor venue 500.

Prior to launching a positioning system within the indoor venue 500, assistance data pertaining to each AP 420 along with the respective positions of each AP 420 may be collected using a test unit. This assistance data and position information may be stored within the indoor AP database 350 (FIG. 3). The assistance data may be collected at each node 530 within the indoor venue 500. However, in some embodiments, the assistance data may be collected anywhere within the indoor venue 500. Accordingly, the data may be sparse compared to the number of nodes 530 within the indoor venue 500. In some embodiments, pre-processing may be performed on the assistance data stored within the indoor AP database 350 (FIG. 3) to remove outliers and spurious measurements.

When the mobile device 100 wishes to initiate positioning, it may initiate a wireless scan for APs 420 that are within communication range of the mobile device 100. Of those APs 420 detected in the scan, the mobile device 100 may determine which AP 420 has the highest received signal strength. The mobile device 100 may communicate information about which AP 420 has the highest received signal strength to the server computer 300 (FIG. 3). Based on information stored within the indoor AP database 350 (FIG. 3), the server computer 300 may respond to the mobile device 100 with a region that the AP 420 having the highest received signal strength is located within. The mobile device 100 may assume, for an initial position estimate, that it is located within the same region.

For example, in FIG. 5C, if the mobile device 100 determines a highest received signal strength from AP F, the mobile device 100 may communicate with the server computer 300 (FIG. 3) and receive information that AP F is located within Region 3. Mobile device 100 may then assume that it is located within Region 3.

Additionally, the mobile device 100 may receive assistance data pertaining to all APs 420 within the region the mobile device 100 has identified being within. As described above, the assistance data may include RSSI and/or RTT information and position information for the APs 420. The assistance data may indicate the RSSI and/or RTT characteristics of each AP from different nodes 530 within the indoor venue 500.

The mobile device 100 may also determine which APs 420 are within communication range. The mobile device 100 may determine APs 420 within communication range from the initial scan performed to determine an AP 420 having the highest signal strength. In other embodiments, the mobile device 100 may perform another wireless scan to determine APs 420 within communication range. For example, in FIG. 5C, the mobile device 100 may determine that only AP F is within communication range.

Using the assistance data received for the region, the mobile device 100 may generate a heatmap for the APs 420 determined to be within communication range. The heatmap may be representative of multiple locations within the region 510, as compared against the signal information pertaining to the one or more access points 420 within communication range. That is, the generated heatmap (for each AP) may indicate expected RSSI and/or RTT values for the AP 420 at different locations within the indoor venue 500. In some embodiments, the different locations may include the nodes 530. In some embodiments, generating the heatmap may be done by interpolating the values received in the assistance data.

From the generated heatmap, the mobile device 100 may refine its initial position estimate. In some embodiments, triangulation methods may be used to determine a refined position estimate. In other embodiments, particle filtering techniques known in the art may be used to obtain a refined position estimate.

In some embodiments, if the mobile device 100 moves to another region, or another location within the same region, the process of determining the location fix may be repeated. Accordingly, new heatmaps may be generated for APs 420 determined to be within communication range of the mobile device 100 at the new location(s). In some embodiments, if the mobile device 100 moves to another region, the assistance data for APs within the new region may be reused without the need to receive them from the server again. For example, if the mobile device 100 initially receives assistance data for APs A, B, C, and D that are within communication range and the mobile device 100 moves to a new region where APs A and C are still within communication range, the received assistance data for APs A and C may be reused without the need to receive them from the server again. Additionally, the generated heatmaps for APs A and C may also be reused without the need to generate the heatmaps again. In some embodiments, a local cache on the mobile device 100 may store received assistance data and/or generated heatmaps for a predetermined period of time or may store a predetermined amount of assistance data and/or generated heatmaps. The local cache is advantageous in that if a user moves back and forth between regions, the process of receiving the assistance data and generating the heatmaps for the APs within the regions need not be constantly repeated upon each transition between the regions. In some embodiments, the local cache may constantly store assistance data and/or generated heatmaps for indoor venues that are determined to be frequently visited venues by the user of the mobile device 100. It can be appreciated that the local cache may be stored within memory 140 or computer-readable medium 190 of the mobile device 100.

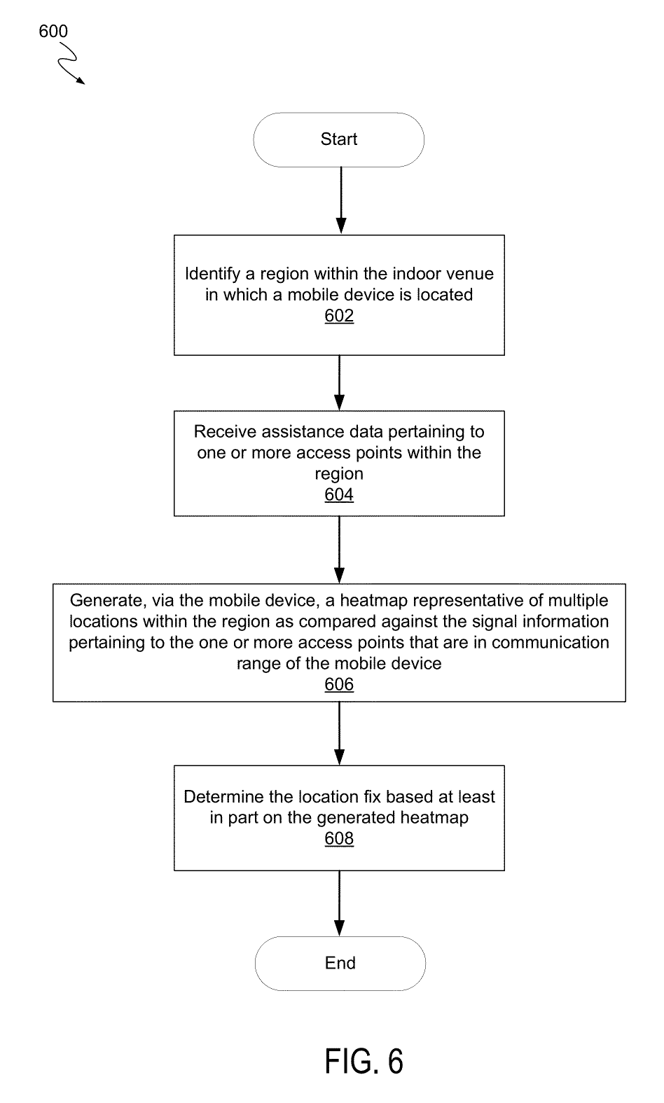

FIG. 6 is an illustrative flow chart 600 depicting an exemplary operation for generating a heatmap on a mobile device within an indoor venue. In block 602, a region within an indoor venue in which the mobile device is located is identified. In some embodiments, the identifying also includes determining an access point that is in communication range of the mobile device having a highest received signal strength and identifying the region as a region in which the access point is located. For example, in FIG. 5C, the mobile device may identify AP 420 as having the highest received signal strength. Based on predetermined knowledge about regions within the indoor venue, the mobile device may be aware that AP 420 is within Region 3 of the indoor venue. As such, the mobile device may identify Region 3 as the region it is currently within.

In block 604, assistance data pertaining to one or more access points within the region is received by the mobile device. In some embodiments, the assistance data is indicative of signal information pertaining to the one or more access points at multiple locations within the region. The signal information may include at least one of a received signal strength indication (RSSI) and round-trip time (RTT). In some embodiments, the assistance data is received from a server computer. The server computer may include an indoor AP database wherein the assistance data is stored. In some embodiments, the assistance data may be indicative of distances between the multiple locations and the access points.

For example, in FIG. 5C, the mobile device may receive assistance data from a server. The assistance data may be stored within an indoor AP database on the server. The assistance data includes RSSI and/or RTT information for the APs within Region 3. The assistance data for APs not within Region 3 may not be sent. The assistance data for Region 3 includes assistance data for AP F and AP G.

In block 606, a heatmap is generated at the mobile device. The heatmap is representative of multiple locations within the region as compared against the signal information pertaining to the one or more access points that are in the communication range. The heatmap may be generated for only the access points that are within the communication range.

In block 608, a location fix of the mobile device is determined based at least in part on the generated heatmap. In some embodiments, determining the location fix includes determining one or more access points within the region that are in communication range of the mobile device. A heatmap may be generated representative of multiple locations within the region as compared against the signal information pertaining to the one or more access points that are in the communication range. The estimated position of the mobile device may be refined based at least in part on the generated heatmap. First, the estimated position may be determined by obtaining RSSI/RTT measurements at a location. The obtained measurements may then be compared to fingerprint data received in the assistance data. The fingerprint data having the closest measurement to the obtained measurement may be used to determine the estimated position. The estimated position may then be refined based on the generating heatmap using the fingerprint data received in the assistance data. First, the estimated position may be determined by obtaining RSSI/RTT measurements at a location. The obtained measurements may then be compared to fingerprint data received in the assistance data. The fingerprint data having the closest measurement to the obtained measurement may be used to determine the estimated position. The estimated position may then be refined based on the generating heatmap using the fingerprint data received in the assistance data.

For example, in FIG. 5C, the mobile device may scan for local APs within its communication range and determine that AP F and AP G are within communication range. The mobile device may locally generate a heatmap for both AP F and AP G. The heatmap may include expected RSSI and/or RTT information at each node (or other locations) within Region 3. Based on the generated heatmaps for AP F and AP G, the mobile device may refine its position estimate using predefined algorithms and/or a particle filter well-known in the art.

In some embodiments, the identifying step, receiving step, and determining step are repeated in response to a change in which APs are within communication range of the mobile device. For example, if the mobile device moves from one location to another within the indoor venue and there is a change in the APs that are within communication range of the mobile device, the method may be repeated to generate new heatmaps for new APs within communication range and determine the location fix again.

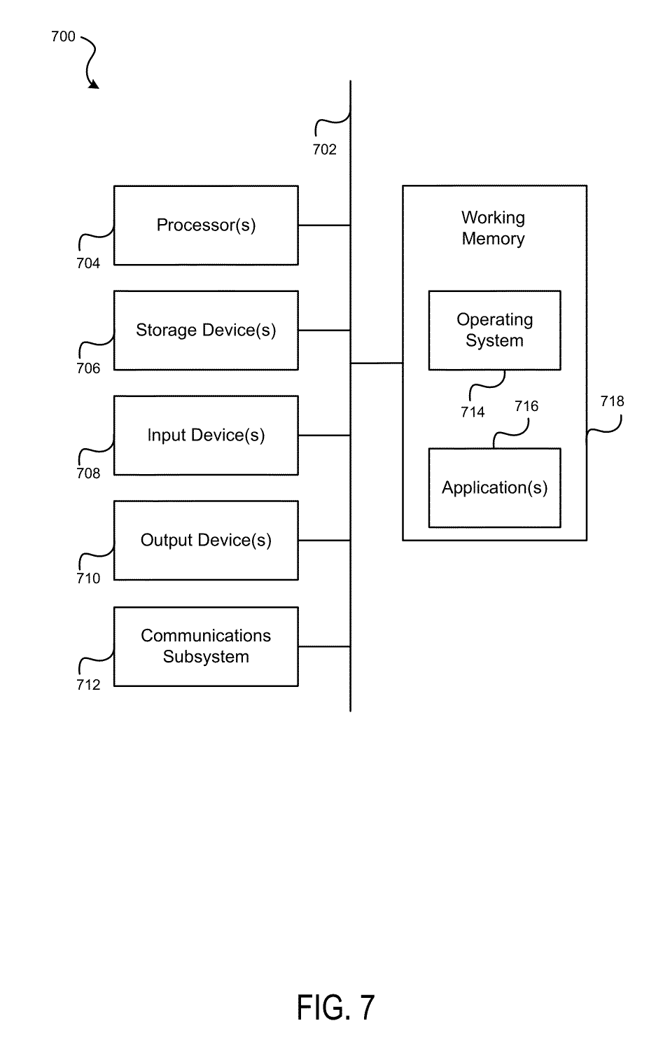

FIG. 7 illustrates an example of a computing system in which one or more embodiments may be implemented. A computer system as illustrated in FIG. 7 may be incorporated as part of the above described computerized device. For example, computer system 700 can represent some of the components of a television, a computing device, a server, a desktop, a workstation, a control or interaction system in an automobile, a tablet, a netbook or any other suitable computing system. A computing device may be any computing device with an image capture device or input sensory unit and a user output device. An image capture device or input sensory unit may be a camera device. A user output device may be a display unit. Examples of a computing device include but are not limited to video game consoles, tablets, smart phones and any other hand-held devices. FIG. 7 provides a schematic illustration of one embodiment of a computer system 700 that can perform the methods provided by various other embodiments, as described herein, and/or can function as the host computer system, a remote kiosk/terminal, a point-of-sale device, a telephonic or navigation or multimedia interface in an automobile, a computing device, a set-top box, a table computer and/or a computer system. FIG. 7 is meant only to provide a generalized illustration of various components, any or all of which may be utilized as appropriate. FIG. 7, therefore, broadly illustrates how individual system elements may be implemented in a relatively separated or relatively more integrated manner. In some embodiments, computer system 700 may be used to implement functionality of the server computer in FIG. 3.

The computer system 700 is shown comprising hardware elements that can be electrically coupled via a bus 702 (or may otherwise be in communication, as appropriate). The hardware elements may include one or more processors 704, including without limitation one or more general-purpose processors and/or one or more special-purpose processors (such as digital signal processing chips, graphics acceleration processors, and/or the like); one or more input devices 708, which can include without limitation one or more cameras, sensors, a mouse, a keyboard, a microphone configured to detect ultrasound or other sounds, and/or the like; and one or more output devices 710, which can include without limitation a display unit such as the device used in embodiments of the invention, a printer and/or the like.

In some implementations of the embodiments of the invention, various input devices 708 and output devices 710 may be embedded into interfaces such as display devices, tables, floors, walls, and window screens. Furthermore, input devices 708 and output devices 710 coupled to the processors may form multi-dimensional tracking systems.

The computer system 700 may further include (and/or be in communication with) one or more non-transitory storage devices 706, which can comprise, without limitation, local and/or network accessible storage, and/or can include, without limitation, a disk drive, a drive array, an optical storage device, a solid-state storage device such as a random access memory (“RAM”) and/or a read-only memory (“ROM”), which can be programmable, flash-updateable and/or the like. Such storage devices may be configured to implement any appropriate data storage, including without limitation, various file systems, database structures, and/or the like.

The computer system 700 might also include a communications subsystem 712, which can include without limitation a modem, a network card (wireless or wired), an infrared communication device, a wireless communication device and/or chipset (such as a BluetoothTM device, an 802.11 device, a Wi-Fi device, a WiMax device, cellular communication facilities, etc.), and/or the like. The communications subsystem 712 may permit data to be exchanged with a network, other computer systems, and/or any other devices described herein. In many embodiments, the computer system 700 will further comprise a non-transitory working memory 718, which can include a RAM or ROM device, as described above.

The computer system 700 also can comprise software elements, shown as being currently located within the working memory 718, including an operating system 714, device drivers, executable libraries, and/or other code, such as one or more application programs 716, which may comprise computer programs provided by various embodiments, and/or may be designed to implement methods, and/or configure systems, provided by other embodiments, as described herein. Merely by way of example, one or more procedures described with respect to the method(s) discussed above might be implemented as code and/or instructions executable by a computer (and/or a processor within a computer); in an aspect, then, such code and/or instructions can be used to configure and/or adapt a general purpose computer (or other device) to perform one or more operations in accordance with the described methods.

A set of these instructions and/or code might be stored on a computer-readable storage medium, such as the storage device(s) 706 described above. In some cases, the storage medium might be incorporated within a computer system, such as computer system 700. In other embodiments, the storage medium might be separate from a computer system (e.g., a removable medium, such as a compact disc), and/or provided in an installation package, such that the storage medium can be used to program, configure and/or adapt a general purpose computer with the instructions/code stored thereon. These instructions might take the form of executable code, which is executable by the computer system 700 and/or might take the form of source and/or installable code, which, upon compilation and/or installation on the computer system 700 (e.g., using any of a variety of generally available compilers, installation programs, compression/decompression utilities, etc.) then takes the form of executable code.

Substantial variations may be made in accordance with specific requirements. For example, customized hardware might also be used, and/or particular elements might be implemented in hardware, software (including portable software, such as applets, etc.), or both. Further, connection to other computing devices such as network input/output devices may be employed. In some embodiments, one or more elements of the computer system 700 may be omitted or may be implemented separate from the illustrated system. For example, the processor 704 and/or other elements may be implemented separate from the input device 708. In one embodiment, the processor is configured to receive images from one or more cameras that are separately implemented. In some embodiments, elements in addition to those illustrated in FIG. 7 may be included in the computer system 700.

Some embodiments may employ a computer system (such as the computer system 700) to perform methods in accordance with the disclosure. For example, some or all of the procedures of the described methods may be performed by the computer system 700 in response to processor 704 executing one or more sequences of one or more instructions (which might be incorporated into the operating system 714 and/or other code, such as an application program 716) contained in the working memory 718. Such instructions may be read into the working memory 718 from another computer-readable medium, such as one or more of the storage device(s) 706. Merely by way of example, execution of the sequences of instructions contained in the working memory 718 might cause the processor(s) 704 to perform one or more procedures of the methods described herein.

The terms “machine-readable medium” and “computer-readable medium,” as used herein, refer to any medium that participates in providing data that causes a machine to operate in a specific fashion. In some embodiments implemented using the computer system 700, various computer-readable media might be involved in providing instructions/code to processor(s) 704 for execution and/or might be used to store and/or carry such instructions/code (e.g., as signals). In many implementations, a computer-readable medium is a physical and/or tangible storage medium. Such a medium may take many forms, including but not limited to, non-volatile media, volatile media, and transmission media. Non-volatile media include, for example, optical and/or magnetic disks, such as the storage device(s) 706. Volatile media include, without limitation, dynamic memory, such as the working memory 718. Transmission media include, without limitation, coaxial cables, copper wire and fiber optics, including the wires that comprise the bus 702, as well as the various components of the communications subsystem 712 (and/or the media by which the communications subsystem 712 provides communication with other devices). Hence, transmission media can also take the form of waves (including without limitation radio, acoustic and/or light waves, such as those generated during radio-wave and infrared data communications).

Common forms of physical and/or tangible computer-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, EPROM, a FLASH-EPROM, any other memory chip or cartridge, a carrier wave as described hereinafter, or any other medium from which a computer can read instructions and/or code.

Various forms of computer-readable media may be involved in carrying one or more sequences of one or more instructions to the processor(s) 704 for execution. Merely by way of example, the instructions may initially be carried on a magnetic disk and/or optical disc of a remote computer. A remote computer might load the instructions into its dynamic memory and send the instructions as signals over a transmission medium to be received and/or executed by the computer system 700. These signals, which might be in the form of electromagnetic signals, acoustic signals, optical signals and/or the like, are all examples of carrier waves on which instructions can be encoded, in accordance with various embodiments of the invention.

The communications subsystem 712 (and/or components thereof) generally will receive the signals, and the bus 702 then might carry the signals (and/or the data, instructions, etc. carried by the signals) to the working memory 718, from which the processor(s) 704 retrieves and executes the instructions. The instructions received by the working memory 718 may optionally be stored on a non-transitory storage device 706 either before or after execution by the processor(s) 704.

The methods, systems, and devices discussed above are examples. Various embodiments may omit, substitute, or add various procedures or components as appropriate. For instance, in alternative configurations, the methods described may be performed in an order different from that described, and/or various stages may be added, omitted, and/or combined. Also, features described with respect to certain embodiments may be combined in various other embodiments. Different aspects and elements of the embodiments may be combined in a similar manner Also, technology evolves and, thus, many of the elements are examples that do not limit the scope of the disclosure to those specific examples.

Specific details are given in the description to provide a thorough understanding of the embodiments. However, embodiments may be practiced without these specific details. For example, well-known circuits, processes, algorithms, structures, and techniques have been shown without unnecessary detail in order to avoid obscuring the embodiments. This description provides example embodiments only, and is not intended to limit the scope, applicability, or configuration of the invention. Rather, the preceding description of the embodiments will provide those skilled in the art with an enabling description for implementing embodiments of the invention. Various changes may be made in the function and arrangement of elements without departing from the spirit and scope of the invention.

Also, some embodiments are described as processes depicted as flow diagrams or block diagrams. Although each may describe the operations as a sequential process, many of the operations can be performed in parallel or concurrently. In addition, the order of the operations may be rearranged. A process may have additional steps not included in the figures. Furthermore, embodiments of the methods may be implemented by hardware, software, firmware, middleware, microcode, hardware description languages, or any combination thereof When implemented in software, firmware, middleware, or microcode, the program code or code segments to perform the associated tasks may be stored in a computer-readable medium such as a storage medium. Processors may perform the associated tasks. Thus, in the description above, functions or methods that are described as being performed by the computer system may be performed by a processor—for example, the processor 704—configured to perform the functions or methods. Further, such functions or methods may be performed by a processor executing instructions stored on one or more computer readable media.

Having described several embodiments, various modifications, alternative constructions, and equivalents may be used without departing from the spirit of the disclosure. For example, the above elements may merely be a component of a larger system, wherein other rules may take precedence over or otherwise modify the application of the invention. Also, a number of steps may be undertaken before, during, or after the above elements are considered. Accordingly, the above description does not limit the scope of the disclosure.

Various examples have been described. These and other examples are within the scope of the following claims.

What is claimed is:

1. A method for generating a heatmap on a mobile device, comprising:
identifying a region in which the mobile device is located;
receiving assistance data pertaining to one or more access points within the region,
wherein the assistance data is indicative of signal information pertaining to the one or more access points at multiple locations within the region;
generating, at the mobile device, a heatmap representative of multiple locations within the region as compared against the signal information pertaining to the one or more access points that are in communication range of the mobile device; and
determining a location fix of the mobile device based at least in part on the generated heatmap.

2. The method of claim 1 wherein the receiving step further comprises determining the one or more access points within the region that are in the communication range of the mobile device.

3. The method of claim 1 wherein the determining step further comprises refining an estimated position of the mobile device based at least in part on the generated heatmap.

4. The method of claim 1 further comprising repeating the identifying step, receiving step, and the determining step in response to determining a change in which of the one or more access points are within the communication range of the mobile device, wherein the determining is based on a change in the signal information.

5. The method of claim 1 wherein the signal information received at the multiple locations comprises at least one of a received signal strength indication (RSSI) and round-trip time (RTT).

6. The method of claim 1 wherein the assistance data is further indicative of distances between the multiple locations and the one or more access points.

7. The method of claim 1 wherein the identifying step further comprises:
determining an access point from the one or more access points that is in communication range of the mobile device having a highest received signal strength; and
identifying the region as a region in which the access point is located.

8. The method of claim 1 wherein the assistance data is received from a server computer.

9. An apparatus for generating a heatmap on a mobile device, comprising:
a processor, wherein the processor is configured to:
generate, at the mobile device, a heatmap representative of multiple locations within a region in which the mobile device is located as compared against signal information pertaining to one or more access points that are in communication range of the mobile device; and
determine a location fix of the mobile device based at least in part on the generated heatmap;
a region identifying module communicatively coupled to the processor and configured to identify the region in which the mobile device is located; and
a wireless transceiver coupled to the processor and configured to receive assistance data pertaining to one or more access points within the region,
wherein the assistance data is indicative of the signal information pertaining to the one or more access points at multiple locations within the region.

10. The apparatus of claim 9 wherein the receiving the assistance data further comprises determining the one or more access points within the region that are in the communication range of the mobile device.

11. The apparatus of claim 9 wherein determining the location fix further comprises refining an estimated position of the mobile device based at least in part on the generated heatmap.

12. The apparatus of claim 9 wherein the processor is further configured to repeat the identifying, receiving, and the determining in response to determining a change in which of the one or more access points are within the communication range of the mobile device, wherein the determining is based on a change in the signal information.

13. The apparatus of claim 9 wherein the signal information received at the multiple locations comprises at least one of a received signal strength indication (RSSI) and round-trip time (RTT).

14. The apparatus of claim 9 wherein the assistance data is further indicative of distances between the multiple locations and the one or more access points.

15. The apparatus of claim 9 wherein the region identifying module is further configured to:
determine an access point of the one or more access points that is in communication range of the mobile device having a highest received signal strength; and
identify the region as a region in which the access point is located.

16. The apparatus of claim 9 wherein the assistance data is received from a server computer.

17. A processor-readable, non-transitory, computer readable medium comprising processor readable instructions configured to cause a processor, on a mobile device, to:
identify a region in which the mobile device is located;
receive assistance data pertaining to one or more access points within the region,
wherein the assistance data is indicative of signal information pertaining to the one or more access points at multiple locations within the region;
generate, at the mobile device, a heatmap representative of multiple locations within the region as compared against the signal information pertaining to the one or more access points that are in communication range of the mobile device; and
determine a location fix of the mobile device based at least in part on the generated heatmap.

18. The processor-readable, non-transitory, computer readable medium of claim 17 wherein the receiving further comprises determining the one or more access points within the region that are in the communication range of the mobile device.

19. The processor-readable, non-transitory, computer readable medium of claim 17 wherein the instructions are further configured to cause the processor to repeat the identifying, receiving, and the determining in response to determining a change in which of the one or more access points are within communication range of the mobile device, wherein the determining is based on a change in the signal information.

20. The processor-readable, non-transitory, computer readable medium of claim 17 wherein the identifying step further comprises:
determining an access point of the one or more access points that is in communication range of the mobile device having a highest received signal strength; and
identifying the region as a region in which the access point is located.
